(19) United States
(12) Patent Application Publication
(10) Pub. No.: US 2003/0219565 A1
(43) Pub. Date: Nov. 27, 2003

(54) Mat apparatus and method

(76) Inventor: Gary Heartsfield, Bedford, TX (US)

Correspondence Address: THOMPSON & KNIGHT L.L.P., PATENT PROSECUTION DEPARTMENT, 98 SAN JACINTO BLVD., SUITE 1200, AUSTIN, TX, 78701, US

(21) Appl. No.: 10/021,208

(22) Filed: Dec. 7, 2001

(51) Int. Cl. B32B 3/10

(52) U.S. Cl. 428/56

(57) ABSTRACT

A floor mat with a seamless top surface and a segmented cushion layer. The seamless top surface eliminates gaps, crevices, and seams that may adversely affect performance or durability of the sports mat. The segmented cushion layer provides an essentially continuous cushioned mat when the mat is in an unrolled configuration and reduces the likelihood of damage to the sports mat due to an exposed top surface or compressed cushion layer. The floor mat may be rolled up into a storage and transportation configuration without turning the mat over. The floor mat is also configured to permit one person to roll and unroll it.

### BACKGROUND OF THE INVENTION

1. Field of the Invention

The present invention relates generally to the field of floor mats. More particularly, it concerns a floor mat for use in sports.

2. Description of Related Art

Sports mats for use in gymnastics, wrestling, and martial arts that are generally comprised of a user surface covering unsegmented secondary cushioning layers are known in the prior art. The use of sports mats in various activities has many advantages over performing the same activities on hard floors, carpeting, or outdoor surfaces. For example, the cushioning helps the athletes to avoid injury. In addition, the user surfaces of sports mats are typically easy to clean. Despite the appeal of sports mats, their use has, at times, proven problematic. Sports mats for space intensive activities such as martial arts or gymnastics floor routines must often cover large areas. Further, it is desirable that the sports mat be movable so that for example a basketball arena can be transformed into a gymnastics arena with the addition of sports mats and other equipment. The two requirements create a host of problems in moving, storing and using the mats, that are not adequately addressed with existing sports mats.

Three types of existing mats address to the inherent difficulties of a large removable sports mat. The first, exemplified by U.S. Pat. No. 3,636,576, is a mat with segmented foam that is foldable for storage. A second approach, exemplified in U.S. Pat. No. 4,350,721, is to create a large floor mat by joining several smaller floor mats with some type of fasteners. The third approach is to use a mat that is rollable. Each of these approaches has shortcomings regarding moving, storing, and using the mats.

Sports mats are often damaged when moved or stored because of the removal and storage procedures necessitated by their size and weight. Most of the weight of the mats generally comes from the cushion layer, which must be a minimum thickness and density to absorb impact from athletes. Advances in cushioning materials have replaced dense hair felt and goat hair mats (see U.S. Pat. No. 3,636,576) with less dense shock absorbing foams. However, even when the cushion layer is one of the modern foams, a large mat is typically heavy enough to require at least two people to set up, move, or stow. Once they are folded or rolled for storage, the mats can be difficult to move.

Straps or other means are typically used to keep sports mats from unrolling. The straps used to constrain the segments may compress the cushion layer, causing it to lose elasticity over time. This compression can lead to accelerated wear of the mat and further problems with its use. Further, as mentioned above, the use of straps may accelerate localized wear in the cushion layer

In addition, mats generally require more than one person for preparing the mats for storage or for use. As noted above, even with modern lightweight foams for cushion layers, large mats are bulky and awkward to roll or fold. In addition to the general bulk of a mat making it difficult to roll/unroll or fold/unfold, the procedures that must be followed to prepare them for storage or installation may be undesirable. For example, many mats must be inverted or flipped so that the user surface is touching the ground before it may be rolled. If such a mat is reinstalled, it must be unrolled, then inverted so the user surface will be facing up. This inversion operation adds time to the installation and removal processes. Rolling and unrolling typically requires two or more people.

Prior art segmented mats, such as that of U.S. Pat. No. 3,636,576, that fold into fairly complex arrangements also require more than one person to install or remove. The complex folding layout requires one person to lift several of the segments while another makes the folds. Further, due to the complexity of the folding layout, the people who remove the mat may need specialized training or, at a minimum, detailed instructions with drawings to fold the mat correctly. Still further, segmented mats with joined individual segments may be installed or removed by one person, however, the process is extremely time consuming, as many individual segments must be placed in the correct orientation and often are then joined with zippers, snaps, or other fasteners. In addition, the installer will need training or detailed directions as the orientation of different mat segments may follow a complex pattern.

The processes required to install and remove existing mats may lead to problems with their use. The local inconsistency in the elastic properties of the mat created by the straps can be extremely dangerous for athletes using the mats. Further local inconsistencies are created at the interface where the segments contact each other in the prior art segmented mats. The prior art rollable mats are stored with the user surface in tension and the cushion layer in compression, damaging both components, and creating local inconsistencies. Typically with such mats, the ends of the mats that were rolled the smallest will exhibit wrinkles in the user surface and have a much softer feel from the lack of surface tension and the compression of the rolled foam. As with the segmented mats, the local inconsistencies may be injurious to athletes using the mats.

In light of the above discussion, it is desirable to manufacture a mat that can be stored without creating local inconsistencies in the mat. In addition, it is desirable to create a mat that can be installed and removed quickly by one person without prior training or detailed directions.

### SUMMARY OF THE INVENTION

In light of the shortcomings of the prior art, it is desirable to have a floor mat with a continuous user surface to prevent injuries attributed to seams, gaps, crevices, and the like. It is also desirable to have a sports mat with a cushion layer that is essentially continuous across the floor mat to avoid injuries caused when a user contacts an area of the mat that does not have cushion material underneath. It would also be desirable to have a floor mat that may be stored in such a manner that does not cause damage to the user surface or cushion layer. It would further be desirable for a floor mat to be lightweight and easily portable.

In one broad embodiment, the present invention is directed to a method for manufacturing a floor mat, comprising the steps of bonding a cushion material layer to a user surface material layer, wherein said user surface material layer does not contain stitching or lamination, and segmenting the cushion material layer. In a narrower embodiment, segmenting the cushion material layer further comprises segmenting the cushion layer with a water jet. In another narrower embodiment, the cushion layer is segmented with a roller cutter. In another narrower embodiment, the user surface material layer is bonded to the cushion material layer using flame lamination.

In another broad embodiment, the present invention is directed to a floor mat comprising a continuous user material layer that has no stitching or laminating and a cushion material layer bonded to the user surface material layer, wherein the cushion material layer is segmented. In a narrower embodiment, the mat is rollable into a storage configuration. In another narrower embodiment, the user surface material layer comprises a skin-compatible layer. In a still narrower embodiment, the user surface material layer comprises vinyl. In another narrower embodiment, the user surface material layer comprises carpet. In another narrower embodiment, the user surface layer material comprises canvas. In yet another narrow embodiment, the cushion material comprises cross linked olefin foam.

### BRIEF DESCRIPTION OF THE DRAWINGS

The following drawings form part of the present specification and are included to further demonstrate certain aspects of the present invention. The drawings are not necessarily drawn to scale. The invention may be better understood by reference to one or more of these drawings in combination with the detailed description of specific embodiments presented herein.

FIG. 1 is a perspective view of a lightweight portable sports mat in an unrolled configuration in accordance with the present invention.

FIG. 2 is side view of the cushion layer of a sports mat in accordance with the present invention.

FIG. 3 is an end view of a sports mat in a rolled up storage configuration in accordance with the present invention.

FIG. 4 is a perspective view of a floor mat rolled into a cone-like configuration.

FIG. 5 is a perspective view of a floor mat rolled into a spiral-like configuration.

### DESCRIPTION OF ILLUSTRATIVE EMBODIMENTS

The present invention addresses the shortcomings of the prior art by providing a sports mat with a top surface and a sectioned cushion layer underneath. The waterproof seamless top surface prevents users from catching body parts, for example a finger or toe, in spaces between adjoining surfaces. Additionally, a user surface that is not stitched greatly reduces the possibility for germs and other unwanted foreign substances to impregnate the user surface. The sectioned cushion layer permits the mat to be rolled and stored without the drawbacks of prior art rollable mats. Accordingly, a sports mat according to the present invention provides a continuous top surface with a segmented cushioned layer that retains the benefits of a continuous cushioned layer, but may easily be removed and stored.

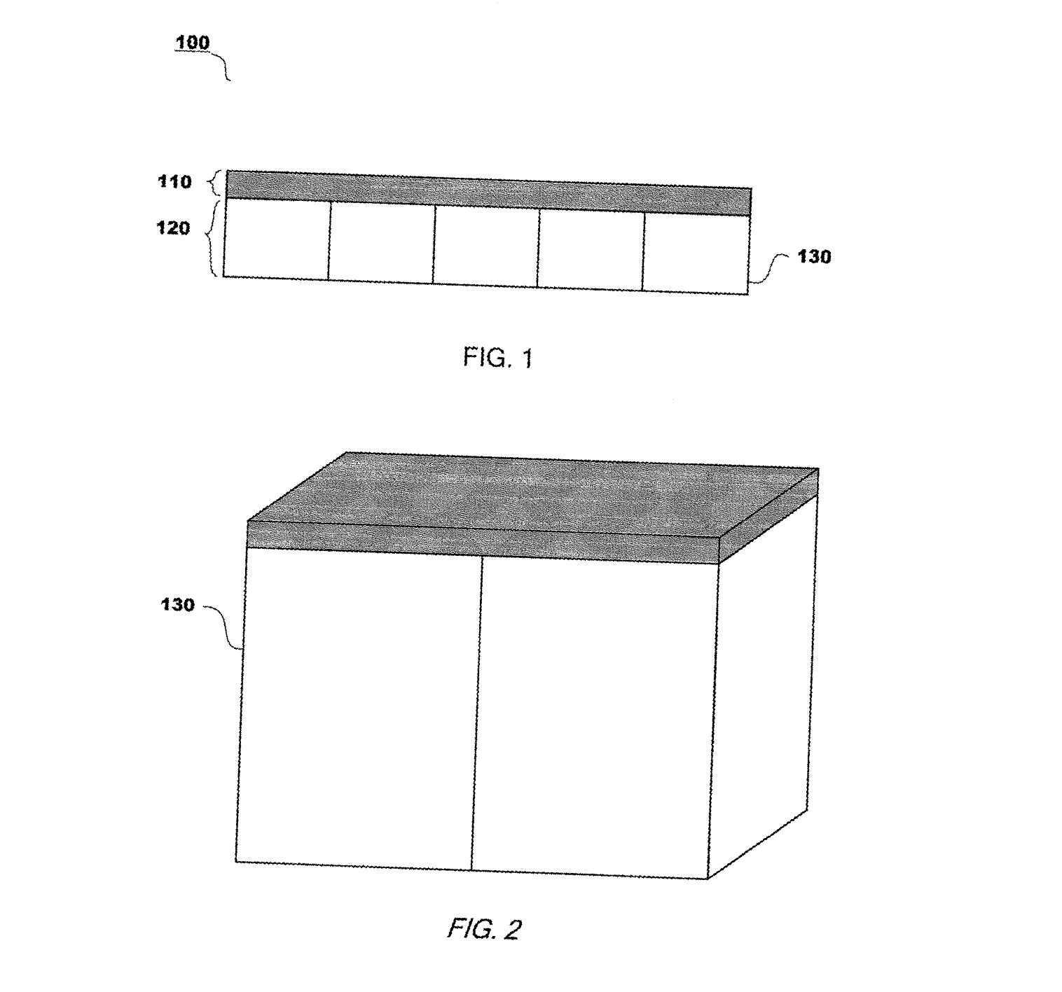

FIG. 1 illustrates a sports mat 100, in an unrolled configuration, in accordance with one embodiment of the present invention. In this embodiment, the user surface 110 is a continuous sheet of skin-compatible material. The present invention is not limited to any particular user surface 110, but by way of example only, user surface 110 may be vinyl, canvas, or carpet. A continuous user surface 110 is advantageous over mats that have seams, gaps, or crevices in the user surface because there is no chance for a user body part or piece of clothing to get caught in a gap and potentially injure the user. Further, the absence of stitching in vinyl, carpet, and canvas surfaces is advantageous because the material is not weakened due to the perforations as a result of stitching. An absence of stitching and perforations of the mat prevents germs, molds, and other substances from impregnating the user surface.

The user surface 110 is bonded to a cushion layer 120. Chemical, thermal, and mechanical methods may be used to bond the user surface layer material to the cushion layer material. Examples of bonding include gluing and/or flame bonding. In one embodiment flame lamination bonds the user surface layer material to the cushion layer material. The present invention is not intended to be limited to the current state of the art in materials bonding: as new processes and methods of materials bonding become available, the present invention contemplates their use in bonding the user surface layer material to the cushion layer material.

The cushion layer 110 provides the shock absorption expected of a sports mat. In one embodiment of the present invention, the cushion layer material is comprised of a cross linked olefin foam (closed cell), often referred to as polyethylene. However, any material or combination of materials with appropriate cushioning capabilities may be used without departing from the scope of the present invention.

A substantially continuous cushion layer 120 is advantageous over mats that have spaces and/or other materials between cushion layer sections because there is no chance for a user to inadvertently land on a portion of the mat 100 that does not have cushioning underneath.

As shown in FIG. 2, the cushion material segments 130 are in direct contact with each other when the mat 100 is in an unrolled position. While other sports mats have enveloped the cushion material segments 130 in covers, an embodiment of the present invention sidewalls and a bottom surface surrounding the cushion material segments 130. The elimination of sidewalls and a bottom surface reduces the overall weight of a sports mat 100 for a given dimension, thereby creating a lightweight and portable sports mat 100.

Methods exist for segmenting the cushion layer 120 based on the material properties of the cushion material, for example roller cutting, laser cutting, or ultrasonic cutting. In one embodiment of the present invention, the cushion layer 120 is bonded to the user surface material 110 and then segmented by using a water jet. The water jet is powerful enough to cut the cushion material 120 but not the user surface material 110. In one embodiment, a water jet operated at 10,000 psi effectively cuts through the cushion material 120 without cutting the user surface material 110. In addition to roller cutting and water jet cutting, embodiments of the present invention are contemplated which employ present and future advances in methods and techniques for segmenting the cushion layer 120.

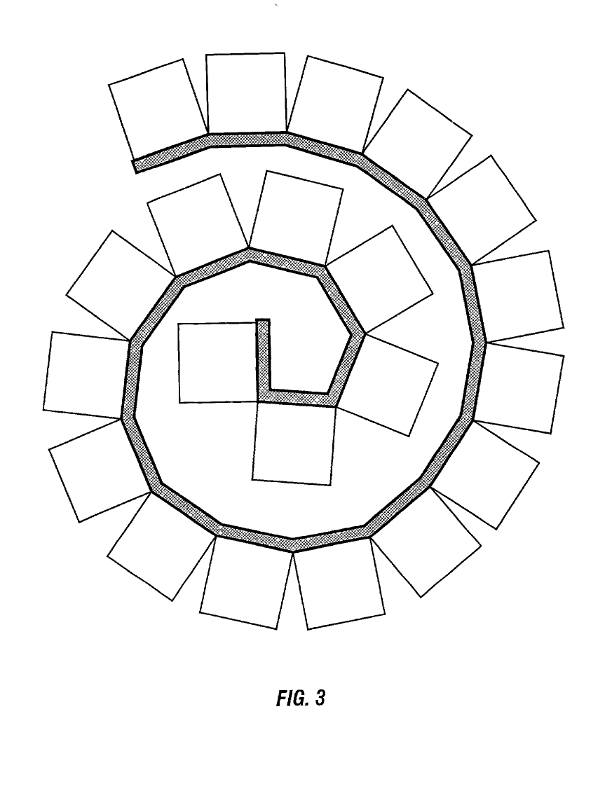

For storage and transportation purposes, a sports mat 100 according to one embodiment of the present invention may be rolled up into the rolled configuration shown in FIG. 3. Segmenting the cushion layer material 120 without enveloping each segment within a user layer shell provides advantages for installation, removal, and storage. One person with no formal training or detailed directions can manipulate embodiments of the present invention. Unlike some prior art mats that are rolled for storage, embodiments of the present invention do not need to be inverted before rolling. Also, embodiments of the present invention can be rolled without creating damaging tensile forces in the user surface or damaging compressive forces in the cushion layer 120. Such tensile and compressive forces have negative effects. For example, when prior art mats are stored with large forces, the cushion material adapts to that configuration. When the mat is then unrolled, the edges then curl, creating an uneven surface and a potentially dangerous situation. Embodiments of the present invention are not exposed to large forces and therefore do not exhibit curled edges. The absence of the large tensile forces and compressive forces makes embodiments of the present invention more durable, less likely to develop local elastic inconsistencies, and therefore safer for athletes than the prior art mats.

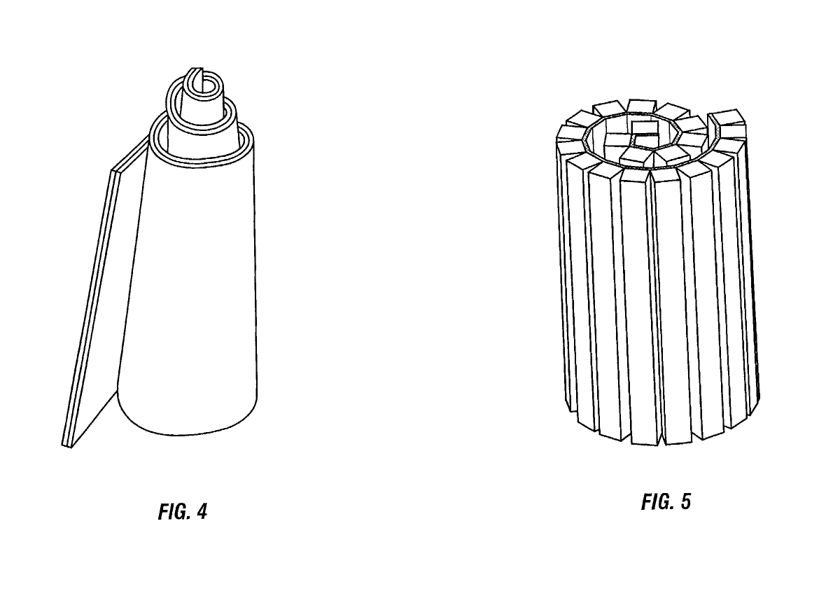

As a further example, FIG. 4 illustrates a negative effect common to prior art mats. When a prior art mat is rolled into a storage configuration, it generally requires two or more people due to internal stresses and loading in the cushion layer material as the material attempts to maintain its configuration. As the people roll the prior art mat into the storage configuration, care is required to prevent asymmetric rolling which could result in the rolled mat developing a cone-like configuration. If the sports mat is stored for a length of time, the cushion layer develops a set and tries to retain that configuration. When the mat is later unrolled, there is a certain unwanted deformity of the sports mat. If the people rolling the sports mat into the storage configuration attempt to correct this problem by relaxing the restraints on the sports mat, the general tendency of the sports mat is to expand. When storage space is limited, as during transportation of sports mats to sporting competitions, this is an undesirable event, and a common remedy would be to unroll and then roll the sports mat again, taking more care during the rolling process.

With respect to the present invention, the rolling process does not typically require large tension and compression forces. Therefore, if a person rolls embodiments of the present invention in such a way as to create a cone configuration, the person can stand the mat on one end, and the sports mat will correct its configuration to a roughly spiral configuration, as illustrated in FIG. 5, which does not damage the mat due to uneven stresses and loading and maintains a smaller, therefore easier to transport, configuration. Furthermore, a mat which has been rolled into substantially a spiral configuration without internal loading and forces does not try to “unroll itself.” Thus, it is easier for a single person to roll a mat made according to the present invention and have the mat retain that configuration without a number of straps exerting substantial forces on the mat.

In a preferred embodiment, a mat, constructed of a cross-linked olefin foam (closed cell) that has been segmented and bonded to a continuous user surface layer, possesses a certain amount of rigidity based on the materials and geometries. Such embodiments are generally more rigid than prior art mats, which contributes to a better storage configuration and therefore a more durable sports mat.

The preceding examples are included to demonstrate specific embodiments of the invention. It should be appreciated by those of skill in the art that the techniques disclosed in the preceding examples represent techniques discovered by the inventor to function well in the practice of the invention, and thus can be considered to constitute preferred modes for its practice. However, it should be understood that the invention is not intended to be limited to the particular forms disclosed. Rather, the different aspects of the disclosed compositions and methods may be utilized in various combinations and/or independently. Thus the invention is not limited to only those combinations shown herein, but rather may include other combinations. Further, those of skill in the art should, in light of the present disclosure, appreciate that many changes can be made in the specific embodiments which are disclosed and still obtain a like or similar result without departing from the spirit and scope of the invention.

What is claimed is:

1. A method for manufacturing a floor mat, comprising the steps of:
bonding a cushion layer material to a user surface layer material; and
segmenting the cushion layer material.

2. The method of claim 1, wherein said step of segmenting the cushion layer material further comprises segmenting the cushion layer material with a water jet.

3. The method of claim 1, wherein said step of segmenting the cushion layer material further comprises segmenting the cushion layer material with a roller cutter.

4. The method of claim 1, wherein the step of bonding the user surface layer material to the cushion layer material comprises bonding the user surface layer material to the cushion layer material with flame lamination.

5. A floor mat, comprising:
a seamless user surface layer material; and
a cushion layer material bonded to said seamless user surface layer material, wherein the cushion layer material is segmented.

6. The floor mat according to claim 5, wherein the mat is rollable into a storage configuration.

7. The floor mat according to claim 6, wherein the storage configuration is roughly cylindrical.

8. The floor mat according to claim 5, wherein said seamless user surface layer material comprises a skin-compatible material.

9. The floor mat according to claim 8, wherein said seamless user surface layer material comprises vinyl.

10. The floor mat according to claim 8, wherein said seamless user surface layer material comprises carpet.

11. The floor mat according to claim 8, wherein said seamless user surface layer material comprises canvas.

12. The floor mat according to claim 5, wherein said cushion layer material comprises closed cell foam.

13. A floor mat, comprising:
a seamless user surface layer material; and
a cushion layer material bonded to said seamless user surface layer material, wherein said cushion layer material is segmented;
wherein the floor mat is capable of being rolled into a roughly spiral configuration such that damages to the user surface layer material due to the tensile and compression forces on said seamless user surface layer material are minimal.

14. The floor mat according to claim 13, wherein said cushion layer material is segmented such that effect of turning the rolled up floor mat on one end would be that the rolled up floor mat would settle into a substantially spiral configuration.

15. The floor mat according to claim 13, wherein said cushion layer material is bonded to said cushion layer material such that effect of turning the rolled up floor mat on one end would be that the rolled up floor mat would settle into a substantially spiral configuration.

16. The floor mat according to claim 13, wherein said cushion layer material is segmented and bonded to said cushion layer material such that effect of turning the rolled up floor mat on one end would be that the rolled up floor mat would settle into a substantially spiral configuration.
